(19) United States
(12) Patent Application Publication
(10) Pub. No.: US 2013/0038291 A1
(43) Pub. Date: Feb. 14, 2013

(54) POWER SUPPLY SYSTEM FOR ELECTRIC LOADS

(71) Applicants: KHOR JOO KEONG, Shenzhen City (CN); WEN-KAO FENG, Shenzhen City (CN)

(72) Inventors: KHOR JOO KEONG, Shenzhen City (CN); WEN-KAO FENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/408,268

(22) Filed: Feb. 29, 2012

(30) Foreign Application Priority Data
Aug. 8, 2011 (CN) 201110225779.3

(51) Int. Cl. H02J 7/02

(52) U.S. Cl. 320/128

(57) ABSTRACT

A system includes an alternating current (AC) power supply for supplying AC power to at least one load circuit; and a backup power supply connected to the AC power supply. The backup power supply includes a filtering and voltage-stabilizing circuit and a charge circuit. When the AC power supply supplies AC power to the at least one load circuit, the filtering and voltage-stabilizing circuit filters the AC power and stabilizes the AC power before sending the filtered and stabilized AC power to the at least one load circuit, and the charge circuit is in a charged state and stores electric power. When the AC power supply is shut off and supplies no power, the filtering and voltage-stabilizing circuit is powered off and stops operating, and the charge circuit is in a discharged state and supplies electric power to the at least one electric load.

### BACKGROUND

1. Technical Field

The present disclosure relates to an uninterruptible power supply system for supplying electric power to electric loads.

2. Description of Related Art

The manufacture or assembly of articles requires a number of processing stations along a manufacturing or assembly line. The processing stations have a number of functions which can, if not executed properly, degrade article quality. Programmable Logic Control (PLC) systems may be used to monitor and control the functions of the processing stations. The processing stations are sometimes required to work uninterrupted. However, if an external alternative current (AC) power supply is shut off suddenly, the processing stations may cease working, causing loss and a decrease in production efficiency.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a system of an embodiment of a power supply system.

FIG. 2 illustrates a detailed block diagram of a backup power supply of the power supply system of FIG. 1.

### DETAILED DESCRIPTION

The disclosure is illustrated by way of example and not by way of limitation. In the figures of the accompanying drawings, like references indicate similar elements.

It should be noted that references to “an” or “one” embodiment in this disclosure are not necessarily to the same embodiment, and such references mean at least one.

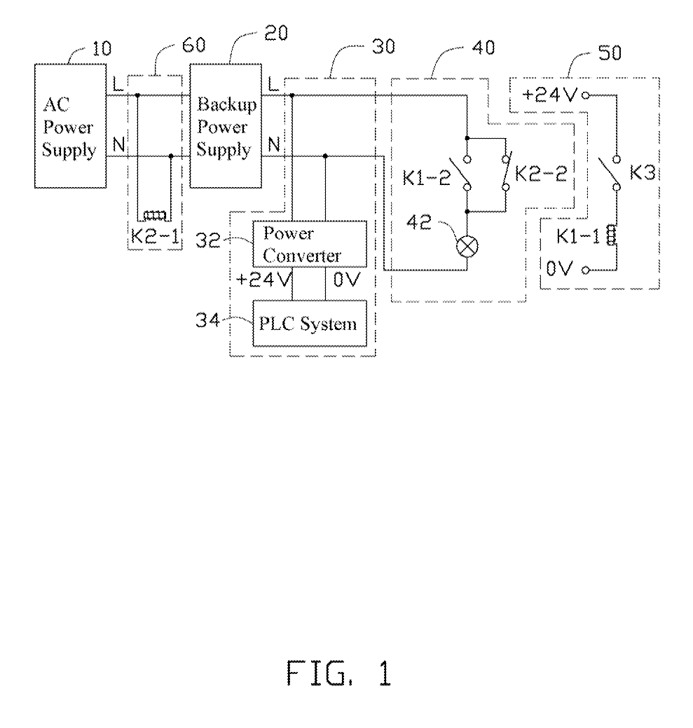

Referring to FIG. 1, an embodiment of a power supply system includes an alternating current (AC) power supply 10, a backup power supply 20, a first load circuit 30, a second load circuit 40, a first switch control circuit 50, and a second switch control circuit 60.

The AC power supply 10 includes a live wire L and a neutral line N. Two input terminals of the backup power supply 20 are connected to the live wire L and the neutral line N. Two output terminals of the backup power supply 20 are connected to the first load circuit 30 and the second load circuit 40.

The first load circuit 30 includes a power converter 32 and a programmable logic control (PLC) system 34. Two input terminals of the power converter 32 are connected to the backup power supply 20. Two output terminals of the power converter 32 are connected to the PLC system 34 for supplying a working voltage to the PLC system 34.

The second load circuit 40 includes a first relay switch K1-2, a second relay switch K2-2, and a lamp 42. The first relay switch K1-2 and the second relay switch

K2-2 are connected in parallel. A first terminal of the lamp 42 is connected to a neutral line N output terminal of the backup power supply 20. A second terminal of the lamp 42 is connected to a live wire L output terminal of the backup power supply 20 via the parallel-connected relay switches K1-2 and K2-2. An on or off state of the first relay switch K1-2 is controlled by the first switch control circuit 50. An on or off state of the second relay switch K2-2 is controlled by the second switch control circuit 60.

The first switch control circuit 50 includes a third switch K3 and a first relay coil K1-1 associated with the first relay switch K1-2. The third switch K3 and the first relay coil K1-1 are connected in series. The first relay coil K1-1 is connected to a +24V power source via the third switch K3. The first relay switch K1-2 is switched off when there is no electric current flowing through the first relay coil K1-1. The first relay switch K1-2 is switched on when there is electric current flowing through the first relay coil K1-1. When the third switch K3 is switched on, there is electric current flowing through the first relay coil K1-1. When the third switch K3 is switched off, there is no electric current flowing through the first relay coil K1-1.

The second switch control circuit 60 includes a second relay coil K2-1 associated with the second relay switch K2-2. A first terminal of the second relay coil K2-1 is connected to the live wire L. A second terminal of the second relay coil K2-1 is connected to the neutral wire N. When the AC power supply 10 outputs AC power normally, there is electric current flowing through the second relay coil K2-1. When the AC power supply 10 is shut off (AC power outage), there is no electric current flowing through the second relay coil K2-1. The second relay switch K2-2 is switched on when there is no electric current flowing through the second relay coil K2-1. The second relay switch K2-2 is switched off when there is electric current flowing through the second relay coil K2-1.

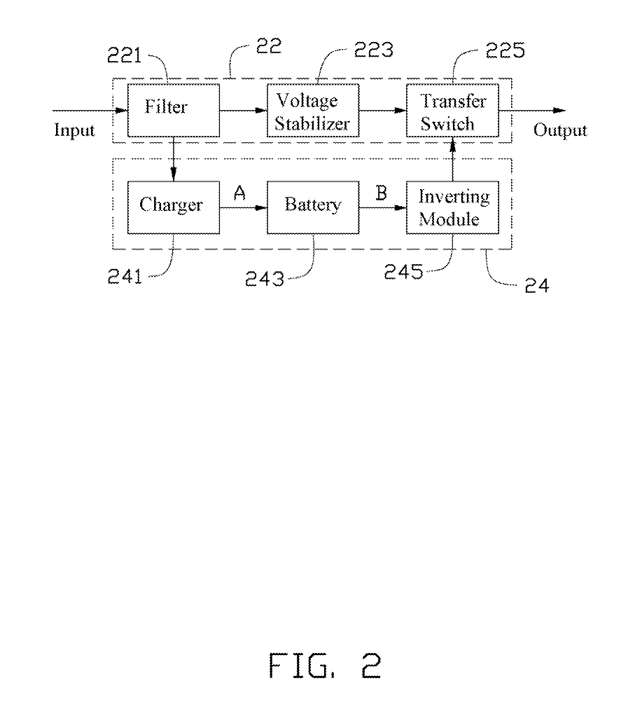

Referring to FIG. 2, the backup power supply 20 includes a filtering and voltage-stabilizing circuit 22 and a charge circuit 24. The filtering and voltage-stabilizing circuit 22 includes a filter 221, a voltage stabilizer 223 connected to the filter 221, a transfer switch 225 connected to the voltage stabilizer 223. The charge circuit 24 includes a charger 241, a battery 243 connected to the charger 241, and an inverting module 245 connected between the battery 243 and the transfer switch 225.

An input terminal of the filter 221 is coupled to receive AC power sent from the AC power supply 10. The filter 221 filters the AC power and outputs the filtered AC power source to the voltage stabilizer 223. The voltage stabilizer 223 stabilizes the AC power and output a stabilized voltage via the transfer switch 225. The charger 241 receives the filtered AC power from the filter 221 and charges the battery 243. When the battery 243 is in a charged state, a first terminal A of the battery 243 is a positive terminal, and a second terminal B of the battery 243 is a negative terminal When the battery 243 is in a discharged state, the inverting module 245 converts the first terminal A to a negative terminal and converts the second terminal B to a positive terminal The battery 243 can then output electric power via the transfer switch 225.

When the AC power supply 10 supplies AC power normally, the filtering and voltage-stabilizing circuit 22 filters the AC power output from the AC power supply 10 and stabilizes a voltage of the AC power before outputting the stabilized voltage to the first load circuit 30 and the second load circuit 40. The power converter 32 converts the voltage output from the backup power supply 20 to a predetermined direct current (DC) voltage (e.g., 24V) and outputs the predetermined DC voltage to the PLC system 34. There is electric current flowing through the second relay coil K2-1 when the AC power supply 10 is powered on. Thus, the second relay switch K2-2 is switched off. The third switch K3 is normally open. There is no electric current flowing through the first relay coil K1-1. The first relay switch K1-2 is switched off. Thus, the lamp 42 is powered off. If users want to light up the lamp 42 when the AC power supply 10 supplies AC power normally, the third switch K3 should be manually switched on. When the third switch K3 is switched on, there is current flowing through the first relay coil K1-1, and the first relay switch K1-2 is switched on. Thus, the lamp 42 can be powered.

When the AC power supply 10 is shut off and supplies no power, the battery 243 supplies electric power to the first load circuit 30 and the second load circuit 40. There is no electric current flowing through the second relay coil K2-1 when the AC power supply 10 is shut off. Thus, the second relay switch K2-2 is switched on. Thus, the lamp 42 is automatically powered when the AC power supply 10 is shut off.

In one embodiment, the transfer switch 225 is connected to the voltage stabilizer 223 and disconnected from the charge circuit 24 when the AC power supply 10 supplies AC power normally. The transfer switch 225 is disconnected from the voltage stabilizer 223 and connected to the charge circuit 24 when the AC power supply 10 is shut on. Therefore, the AC power supply 10 and the battery 243 will not simultaneously supply electric power to electric loads. When the AC power supply 10 supplies AC power normally, the battery 243 is in a charging state. When the AC power supply 10 is shut off, the battery 243 is in a discharging state and supplies power to electric loads. Thus, the power supply system can supply uninterrupted electric power, which may eliminate undesirable effect of production efficiency.

While the present disclosure has been illustrated by the description in this embodiment, and while the embodiment has been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

What is claimed is:

1. A system comprising:
an alternating current (AC) power supply;
a first load circuit; and
a backup power supply connected between the AC power supply and the first load circuit, the backup power supply comprising a filtering and voltage-stabilizing circuit and a charge circuit;
wherein when the AC power supply supplies AC power to the first load circuit, the filtering and voltage-stabilizing circuit filters the AC power and stabilizes the AC power before sending the filtered and stabilized AC power to the first load circuit, and the charge circuit is in a charged state and stores electric power;
when the AC power supply is shut off and supplies no power, the filtering and voltage-stabilizing circuit is powered off and stops operating, and the charge circuit is in a discharged state and supplies electric power to the first electric load.

2. The system of claim 1, wherein the filtering and voltage-stabilizing circuit comprises a filter coupled to receive the AC power, a voltage stabilizer connected to the filter, and a transfer switch, the transfer switch is connected to the voltage stabilizer and disconnected from the charge circuit when the AC power supply supplies AC power, and the transfer switch is disconnected from the voltage stabilizer and connected to the charge circuit when the AC power supply is shut off.

3. The system of claim 2, wherein the charge circuit comprises a charger connected to the filter and a battery connected to the charger, the charger is configured to charge the battery when the AC power supply supplies AC power, and the battery is in a discharged state and supplies electric power to the first load circuit when the AC power supply is shut off.

4. The system of claim 3, wherein the charge circuit further comprises an inverting module connected between the battery and the transfer switch, the inverting module is configured to invert positive and negative terminals of the battery; when the battery is in the charged state, the positive terminal of the battery is connected to the charger, and the negative terminal of the battery is connected to the inverting module; and when the battery is in the discharged state, the positive terminal of the battery is connected to the inverting module, and the negative terminal of the battery is connected to the charger.

5. The system of claim 1, wherein the first load circuit comprises a power converter connected to the backup power supply and a programmable logic control (PLC) system connected to the power converter, the power converter is configured to convert a voltage output from the backup power supply to a predetermined direct current voltage.

6. The system of claim 5, further comprising a second load circuit, wherein the second load circuit comprises a lamp, a first relay switch, and a second relay switch, the first relay switch and the second relay switch are connected in parallel, the lamp is connected to the backup power supply via the first relay switch and second relay switch.

7. The system of claim 6, further comprising a first switch control circuit configured to control an on or off state of the first relay switch and a second switch control circuit configured to control an on or off state of the second relay switch.

8. The system of claim 7, wherein the first switch control circuit comprises a third switch and a first relay coil configured to control the on or off state of the first relay switch, the first relay coil is connected to a +24 volts power source via the third switch.

9. The system of claim 8, wherein the first relay switch is switched on when there is electric current flowing through the first relay coil, the first relay switch is switched off when there is no current flowing through the first relay coil.

10. The system of claim 7, wherein the second switch control circuit comprises a second relay coil connected to the AC power supply and configured to control the on or off state of the second relay switch, the second relay switch is switched on when there is no electric current flowing through the second relay coil, and switched off when there is electric current flowing through the second relay coil.

11. A system comprising:
an alternating current (AC) power supply for supplying AC power to at least one load circuit; and
a backup power supply connected to the AC power supply and comprising a filtering and voltage-stabilizing circuit and a charge circuit;
wherein when the AC power supply supplies AC power to the at least one load circuit, the filtering and voltage-stabilizing circuit filters the AC power and stabilizes the AC power before sending the filtered and stabilized AC power to the at least one load circuit, and the charge circuit is in a charged state and stores electric power;
when the AC power supply is shut off and supplies no power, the filtering and voltage-stabilizing circuit is powered off and stops operating, and the charge circuit is in a discharged state and supplies electric power to the at least one electric load.

12. The system of claim 11, wherein the filtering and voltage-stabilizing circuit comprises a filter coupled to receive the AC power, a voltage stabilizer connected to the filter, and a transfer switch, the transfer switch is connected to the voltage stabilizer and disconnected from the charge circuit when the AC power supply supplies AC power, and the transfer switch is disconnected from the voltage stabilizer and connected to the charge circuit when the AC power supply is shut off.

13. The system of claim 12, wherein the charge circuit comprises a charger connected to the filter and a battery connected to the charger, the charger is configured to charge the battery when the AC power supply supplies AC power, and the battery is in the discharged state and supplies electric power to the at least one load circuit when the AC power supply is shut off.

14. The system of claim 13, wherein the charge circuit further comprises an inverting module connected between the battery and the transfer switch, the inverting module is configured to invert positive and negative terminals of the battery; when the battery is in the charged state, the positive terminal of the battery is connected to the charger, and the negative terminal of the battery is connected to the inverting module; and when the battery is in the discharged state, the positive terminal of the battery is connected to the inverting module, and the negative terminal of the battery is connected to the charger.

15. The system of claim 11, wherein the at least one load circuit comprises a power converter connected to the backup power supply and a programmable logic control (PLC) system connected to the power converter, the power converter is configured to convert a voltage output from the backup power supply to a predetermined direct current voltage.

16. The system of claim 11, wherein the at least one load circuit comprises a lamp, a first relay switch, and a second relay switch, the first relay switch and the second relay switch are connected in parallel, the lamp is connected to the backup power supply via the first relay switch and second relay switch.

17. The system of claim 16, further comprising a first switch control circuit configured to control an on or off state of the first relay switch and a second switch control circuit configured to control an on or off state of the second relay switch.

18. The system of claim 17, wherein the first switch control circuit comprises a third switch and a first relay coil configured to control the on or off state of the first relay switch, the first relay coil is connected to a +24 volts power source via the third switch.

19. The system of claim 18, wherein the first relay switch is switched on when there is electric current flowing through the first relay coil, the first relay switch is switched off when there is no current flowing through the first relay coil.

20. The system of claim 7, wherein the second switch control circuit comprises a second relay coil connected to the AC power supply and configured to control the on or off state of the second relay switch, the second relay switch is switched on when there is no electric current flowing through the second relay coil, and switched off when there is electric current flowing through the second relay coil.
